(19) United States
(12) Patent Application Publication
(10) Pub. No.: US 2026/0298319 A1
(43) Pub. Date: Oct. 1, 2026

(54) ROLLER CAGE ELEMENT HAVING PROFILED ROLLERS FOR A ROLLER SCREW DRIVE

(71) Applicant: Schaeffler Technologies AG & Co. KG, Herzogenaurach (DE)

(72) Inventor: Hans-Joachim Troesch, Hermeskeil (DE)

(73) Assignee: Schaeffler Technologies AG & Co. KG, Herzogenaurach (DE)

(21) Appl. No.: 19/476,520

(22) PCT Filed: Apr. 24, 2024
(86) PCT No.: PCT/DE2024/100367

§ 371 Date: Oct. 17, 2025

(30) Foreign Application Priority Data
Jun. 16, 2023 (DE) 10 2023 115 828.7

(51) Int. Cl. F16H 25/24; F16H 25/22

(52) U.S. Cl. CPC F16H 25/24; F16H 25/2252

(57) ABSTRACT

A roller cage element for a roller screw drive has a roller cage with cage pockets and rim rings with bearing pockets, and profiled rollers are arranged around a longitudinal axis of the roller cage in the cage pockets and spaced from one another circumferentially. The profiled rollers have end pins that engage in the bearing pockets of the rim rings of the roller cage. The bearing pockets are radially open for the radial insertion of the profiled rollers and each have an operating seat for the profiled rollers and installation seat for the profiled rollers. For the assembly of the roller cage element, the profiled rollers are arranged on a first pitch circle around a cage axis and, for the operation of the roller screw drive, said profiled rollers are arranged on a second pitch circle arranged around the cage axis.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2024/100367, filed on Apr. 24, 2024, designating the United States of America, which in turn claims the benefit of priority under 35 U.S.C. § § 119, 365 of German Patent Application No. 102023115828.7, filed on Jun. 16, 2023, the contents of which are relied upon and incorporated herein by reference in their entirety.

### FIELD OF THE DISCLOSURE

The present disclosure relates to a roller cage element for a roller screw drive, having profiled rollers which are rotatably mounted in a roller cage.

### BACKGROUND OF THE DISCLOSURE

A roller screw drive designed as a roller threaded drive has become known from U.S. Pat. No. 10,584,777 B2. A roller cage element has profiled rollers, which are arranged around a longitudinal axis of a roller cage, in the cage pockets of which roller cage the profiled rollers are spaced from one another circumferentially. End pins of the profiled rollers engage in bearing pockets of rim rings of the roller cage. The end pins have a cylindrical portion and, in this particular case, a gear portion that meshes with a ring gear of the nut of the roller screw drive. This roller screw drive is synchronized in this way.

The roller cage has projections distributed over the circumference and arranged along the axis of rotation, at the axial ends of which the rim rings are arranged, and projections arranged adjacent to one another delimit U-shaped cage pockets for receiving the profiled rollers. These cage pockets keep the profiled rollers spaced apart circumferentially. The cage pockets, which open radially inwards, are helpful for inserting the profiled rollers with their cylindrical pins into the roller cage from the radial inside. The roller cage element is screwed onto a threaded spindle of the roller screw drive. For installation, measures must be taken to enable the roller cage element to be installed on the threaded spindle of the roller screw drive.

### SUMMARY OF THE DISCLOSURE

The disclosure provides a roller cage element for a roller screw drive which can be easily installed on a threaded spindle or in a nut of the roller screw drive.

The roller cage element for a roller screw drive has profiled rollers, which are arranged around a longitudinal axis of the roller cage. The longitudinal axes of the roller cage and the roller screw drive coincide.

The profiled rollers can be provided with a helical thread which is wound around the roller axis on the outer circumference and which meshes with a nut-side and/or a spindle-side thread.

The profiled rollers can be provided with a plurality of mutually parallel grooves and teeth which are arranged one behind the other and transverse to the roller axis. Profiled rollers of this type can be used in planetary roller screw drives and roller screw drives. In planetary roller screw drives, the profiled rollers designed as planetary rollers rotate both around their roller axis and around the axis of a threaded spindle. In the case of a roller screw drive, the profiled rollers can rotate around their roller axis and, for example, be arranged stationary.

In cage pockets of the roller cage, the profiled rollers are arranged spaced from each other circumferentially. This circumferential spacing and the sequence of profiled rollers circumferentially depend on the type and pitch of the roller screw drive. For example, in the case of a planetary roller screw drive, the profiled rollers designed as planetary rollers mesh with a thread of a threaded spindle of the screw drive. The planetary rollers distributed over the circumference must be designed and positioned according to the pitch of the thread of the threaded spindle if their axial end faces are to lie in common planes.

The roller cage may preferably have projections distributed over the circumference and arranged along the axis of rotation, at the axial ends of which the rim rings are arranged, and projections arranged adjacent to one another delimit the cage pockets for receiving the profiled rollers. The projections and the rim rings can be manufactured in one piece, or alternatively they can be individual components that are connected to each other in a form-fitting manner, for example in the form of a plug-in connection.

End pins of the profiled rollers engage in bearing pockets of the rim rings of the roller cage. The profiled rollers are mounted in the bearing pockets so they can rotate about the axis of the cylindrical pins. The bearing pockets are distributed over the circumference of the rim rings and define the circumferential spacing between the profiled rollers.

The bearing pockets are radially open for the radial insertion of the profiled rollers and each have an operating seat for the profiled rollers and an installation seat for the profiled rollers that is radially spaced from the operating seat. For example, the bearing pockets can be U-shaped when viewed axially and can be open either radially outwards or radially inwards.

The profiled rollers can be inserted on the radially open side of the bearing pockets, the pins engaging in the bearing pockets. To install the roller cage element, the profiled rollers are inserted radially into the bearing pockets until they are seated in their installation seat. The installation seat can be designed such that the pins of the profiled rollers snap therein. A specific embodiment is described below.

In any case, the profiled rollers are held captively in the installation seat and do not easily fall out of the bearing pockets. The installation seat enables the roller cage element to be installed, for example, with a threaded spindle. This means that the inner enveloping circle diameter of the roller cage element is larger than the enveloping circle diameter of the threaded spindle, and the profiled rollers of the cage element do not interfere with the threaded spindle being pushed together with the roller cage element. If the roller cage element is to be installed with a nut of the screw drive, the outer enveloping circle diameter of the roller cage element is smaller than the enveloping circle diameter of the nut on its inner circumference. The enveloping circle diameter envelops a body having its greatest extent equal to the diameter of the enveloping circle. An outer enveloping circle diameter envelops an outer contour of the body. An inner enveloping circle lies within a hollow body that is tangent to the inner enveloping circle at its narrowest point.

When the roller cage element is installed with other essential components of the roller screw drive, the profiled rollers are moved out of their installation seat in the bearing pockets by radial displacement and radially displaced into their operating seat, where they mesh with their associated mating roller element, i.e. with a threaded spindle or with a nut of the roller screw drive.

The installation seat of the profiled rollers is located on a first pitch circle around a cage axis of the roller cage. This pitch circle is dimensioned such that the profiled rollers do not collide with the mating roller element into or onto which they are pushed during installation of the roller cage element.

If the roller cage element is to be pushed onto a threaded spindle, an inner enveloping circle diameter of the roller cage element is larger than an outer enveloping circle diameter of the threaded spindle. When the roller cage element is inserted into a nut, an outer enveloping circle diameter of the roller cage element is larger than an inner enveloping circle diameter of the nut.

When the roller cage element is assembled with the intended mating roller element and the profiled rollers have been moved from their installation seat to the operating seat by radial displacement, the profiled rollers mesh with their mating roller element, i.e. with the threaded spindle or with the nut of the roller screw drive.

The first and second pitch circles are located on different pitch circles around the cage axis, the diameters of which are designed according to the function of the installation seat and the operating seat.

If the roller cage element is to be installed with a threaded spindle, the first pitch circle for the installation seat is larger than the second installation seat for the operating seat.

If the roller cage element is to be installed with a nut of the screw drive, the first pitch circle for the installation seat is smaller than the second installation seat for the operating seat.

The disclosure therefore enables easy mounting of the roller cage element with the intended mating roller element, i.e. threaded spindle or nut, without the need for additional components.

The bearing pockets are preferably each delimited on each rim ring circumferentially by opposing pocket walls, which radially form pairs of retaining portions for the profiled rollers, each retaining portion being associated with one of the two pitch circles.

Two opposing and mutually facing pocket walls as a pair therefore form a retaining portion. This retaining portion forms the installation seat for the profiled rollers. In the same way, a further radially spaced retaining portion can form the operating seat. In the installation seat and in the operating seat, the profiled rollers on their pins can therefore be enclosed by the pocket walls of the rim rings of the roller cage to such an extent that the profiled rollers are captively held in the installation seat and reliably mounted in the operating seat.

The aforementioned retaining portion can be formed by two circumferentially opposing, mutually facing, curved wall portions of the pocket walls, which can be in the shape of a pitch circle, i.e. matched to the diameter of the pin of the profiled roller. Viewed axially, the wall portions are therefore curved concavely. When the profiled rollers are inserted into the roller cage, they can snap into this retaining portion. Appropriate shaping of the pocket walls and choosing of a suitable material with sufficiently high elasticity ensure said rollers snap into place. The wall portions can be concave in shape.

The pocket walls can preferably, as viewed axially, each have two curved wall portions which are disposed radially one behind the other and which engage partially around the pins of the profiled rollers, a clear spacing between two opposing curved wall portions associated with one of the two pitch circles being smaller than a pin diameter of the pins of the profiled rollers.

More generally, the bearing pocket may have a clear opening width that is smaller than the diameter of the pins.

For installing the roller cage element on a threaded spindle of the roller screw drive, a method according to the following steps is proposed. The profiled rollers are placed into their installation seat in the roller cage, in which the roller cage element has an inner enveloping circle diameter that is larger than the outer diameter of the threaded spindle. The notional enveloping circle is large enough to be tangent to the profiled rollers arranged distributed over the circumference. Now the roller cage element and the threaded spindle are pushed into each other without the profiled rollers coming into contact with the threaded spindle. After being pushed into each other, the profiled rollers are radially displaced inwards into the operating seat, in which the profiled rollers are in engagement with the threaded spindle. A nut of the roller screw drive is then screwed onto the roller cage element.

For installing the roller cage element with a nut of the roller screw drive, a method according to the following steps is proposed. The profiled rollers are inserted into the roller cage in the installation seat, in which the roller cage element has an outer enveloping circle diameter that is smaller than an inner diameter of the nut. The notional enveloping circle is large enough to be tangent to the profiled rollers arranged distributed over the circumference. Now the roller cage element is inserted into the nut without the profiled rollers coming into contact with the nut. The profiled rollers are then radially displaced into the operating seat, in which the profiled rollers engage with the nut. A threaded spindle is then screwed into the roller cage element. The nut can be a two-part nut element assembled from rings, or it can be a one-part profiled nut.

### BRIEF DESCRIPTION OF THE DRAWINGS

The disclosure is explained in more detail below with reference to two exemplary embodiments shown in a total of 12 figures. In the drawing:

FIG. 1 shows a first exemplary embodiment of a roller cage element in a perspective representation;

FIG. 2 shows a cage of the roller cage element from FIG. 1 in a perspective representation;

FIG. 3 shows the roller cage element from FIG. 1 in a side view in the installation position;

FIG. 4 shows the roller cage element from FIG. 3 in the operating position;

FIG. 5 shows an enlarged detail of FIG. 3;

FIG. 6 shows a further enlarged detail of the cage of the roller cage element from FIG. 3;

FIG. 7 shows a schematic representation of the roller cage element with a threaded spindle of a screw drive in the installation position;

FIG. 8 shows a schematic representation of the roller cage element as in FIG. 7 in the operating position;

FIG. 9 shows a further exemplary embodiment in a perspective representation;

FIG. 10 shows an enlarged detail of FIG. 9;

FIG. 11 shows a schematic representation of the exemplary embodiment according to FIG. 9 with a nut of a screw drive in an installation position of the roller cage element; and

FIG. 12 shows a schematic representation as in FIG. 11 in the operating position of the roller cage element.

### DETAILED DESCRIPTION

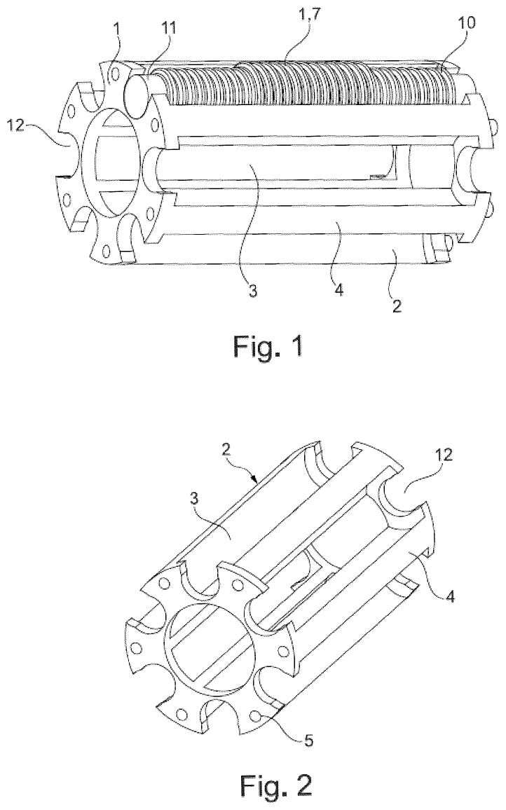

The exemplary embodiment shown in FIGS. 1 to 8 shows a first embodiment of a roller cage element for a roller screw drive, with profiled rollers 1 arranged around a longitudinal axis of a roller cage 2, in the cage pockets 3 of which the profiled rollers 1 are spaced from one another circumferentially.

The roller cage 2 has projections 4 distributed over the circumference and arranged along the axis of rotation, at the axial ends of which rim rings 5 are arranged, wherein projections 4 arranged adjacent to one another delimit cage pockets 3 for receiving the profiled rollers 1.

The profiled rollers 1 have a larger engagement profile 7 for engagement in a spindle-side thread 8 of a threaded spindle 9 (see FIG. 8). On both sides of the larger engagement profile 7, a smaller engagement profile 10 is formed on the profiled roller 1 for engagement in a nut-side profile of a nut of the screw drive (not shown).

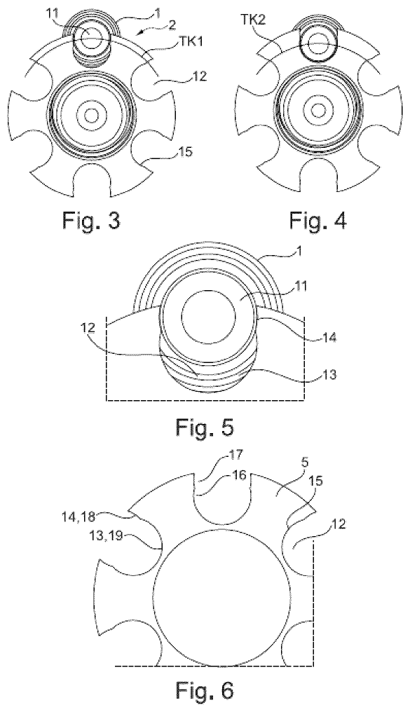

FIGS. 3 and 4 show that the profiled rollers 1 are provided at their axial ends with pins 11 which engage in bearing pockets 12 of the rim rings 5 of the roller cage 2. The bearing pockets 12 can be clearly seen, for example, in FIG. 2. The bearing pockets 12 each have a U-shaped contour, open radially outwards, when viewed axially.

The bearing pockets 12 each have an operating seat 13 for the profiled rollers 1 and an installation seat 14 for the profiled rollers 1, which is radially spaced from the operating seat 13 (see FIG. 5). In the installation seat 14, the profiled rollers 1 are held so as to be prevented from falling out of the roller cage 2 radially.

The profiled rollers 1 are inserted radially from the outside into the bearing pockets 12 under elastic deformation of the pocket walls 15 and snap into their installation seat 14. By means of radial displacement, the profiled rollers 1 are snapped into their operating seat 13 under elastic deformation of the pocket walls 15.

FIG. 6 shows an enlarged detail of the radially outer installation seat 14 for the profiled rollers 1 for installing the roller cage element as well as the operating seat 13 for the profiled rollers 1. In the installation seat 14, the profiled rollers 1 are arranged on a first pitch circle TK1 arranged around the cage axis and, for operation of the roller screw drive, on a second pitch circle TK2 arranged around the cage axis (see FIGS. 3 and 4). The axes of rotation of the profiled rollers 1 are located on the first pitch circle TK1 in the installation seat and on the second pitch circle TK2 in the operating seat.

It can be clearly seen from FIG. 6 that the bearing pockets 12 are each delimited circumferentially by opposing pocket walls 15, which are formed on both rim rings 5 in a manner distributed over the circumference. In pairs, the two opposing pocket walls 15 form two retaining portions 16, 17, arranged radially one behind the other, for the profiled rollers 1 in a radial direction.

The radially outer retaining portion 16 for the installation seat 14 is formed by curved wall portions 18 on both pocket walls 15, which partially engage around the pins 11 of the profiled rollers 1 over a segment of the circumference, and, viewed from the radial outside, a clear spacing between the two opposing curved wall portions 18 is smaller than the pin diameter of the pins 11 of the profiled rollers 1.

The radially inner retaining portion 17 for the operating seat 14 is formed by curved wall portions 19 on both pocket walls 15, which partially engage around the pins 11 of the profiled rollers 1 over a segment of the circumference, and, viewed from the radial outside, a clear spacing between the two opposing curved wall portions 19 is smaller than the pin diameter of the pins 11 of the profiled rollers 1.

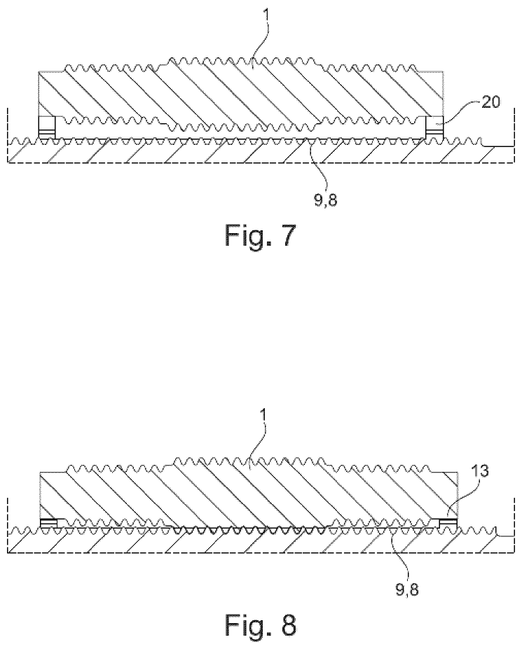

FIGS. 7 and 8 show two installation steps. In the first installation step (FIG. 7), the profiled rollers 1 are snapped into the installation seat 14.

FIG. 7 clearly shows that an inner enveloping circle diameter of the roller cage element is larger than an outer diameter or enveloping circle diameter of the threaded spindle 9. The roller cage element can be pushed onto the threaded spindle 9 without interfering contact with the threaded spindle 9.

FIG. 8 shows the roller cage element with the profiled rollers 1 in the operating seat 13, which mesh with the threaded spindle 9.

A nut element (not shown) can then be screwed onto the profiled roller element.

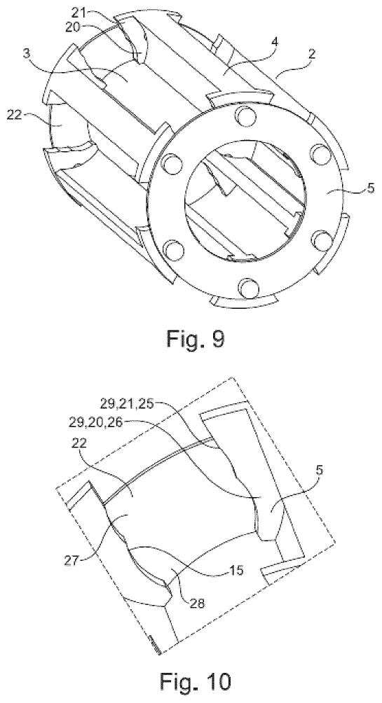

The embodiment shown in FIGS. 9 to 12 differs from the first exemplary embodiment substantially by a radially interchanged arrangement of the installation seat and the operating seat as well as by radially continuously open bearing pockets 22 in the rim rings 5.

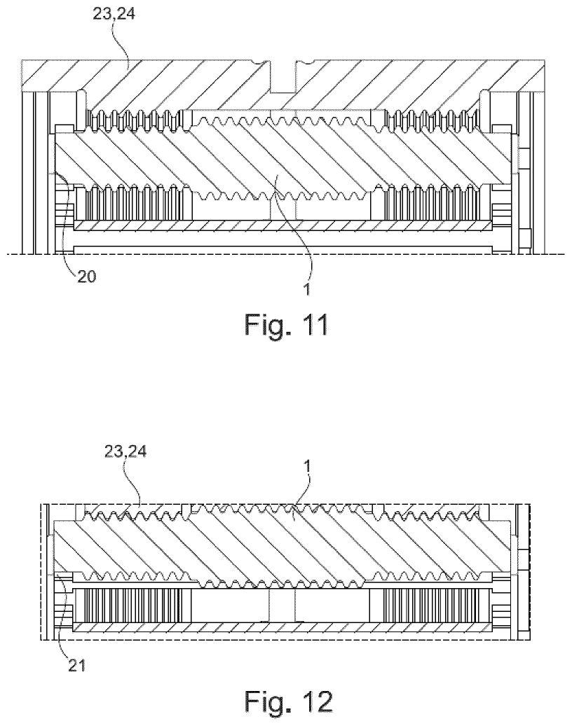

FIGS. 9 and 10 show that the bearing pockets 22 are continuously open radially. An installation seat 20 is arranged radially inside and an operating seat 21 is arranged radially outside in the bearing pockets 22. In the installation seat 20, the profiled rollers rest on a radially inner first pitch circle TK1. In the operating seat, the profiled rollers 1 rest on a radially outer second pitch circle TK2.

Just as in the previously described exemplary embodiment, pocket walls 29 of the bearing pockets 22 are designed as curved wall portions 25, 26 which are arranged radially one behind the other. Circumferentially opposing curved wall portions 25, 26 form retaining portions 27, 28 for the profiled rollers 1 in the installation seat 20 and in the operating seat 21.

According to this exemplary embodiment, the installation sequence is such that the profiled rollers 1 are firstly inserted radially into the roller cage 2 into the installation seat 20 and snap into the installation seat 20 similarly to the previously described exemplary embodiment, in which the roller cage element has an outer enveloping circle diameter which is smaller than the inner diameter of a nut element 23, which in this exemplary embodiment is formed from individual nut rings 24.

Now the roller cage element and the nut element 23 are pushed into each other. It can be clearly seen from FIG. 11 that there is a radial spacing between the profiled rollers 1 and the nut element 23, so that unwanted contact during installation is prevented.

In a next step, the profiled rollers 1 are displaced into the operating seat 21, in which the profiled rollers 1 are in engagement with the nut element 23. This installation step is shown in FIG. 12.

The threaded spindle 8 (not shown here) can then be screwed in.

### List of Reference Signs

1 Profiled roller
2 Roller cage
3 Cage pocket
4 Projection
5 Rim ring
6
7 Engagement profile
8 Spindle-side thread
9 Threaded spindle
10 Smaller engagement profile
11 Pins
12 Bearing pocket
13 Operating seat
14 Installation seat
15 Pocket wall
16 Retaining portion
17 Retaining portion
18 Curved wall portion
19 Curved wall portion
20 Installation seat
21 Operating seat
22 Bearing pocket
23 Nut element
24 Nut ring
25 Curved wall portion
26 Curved wall portion
27 Retaining portion
28 Retaining portion
29 Pocket wall

1. A roller cage element for a roller screw drive, the roller cage element comprising:
a roller cage having cage pockets and rim rings having bearing pockets; and
profiled rollers arranged around a longitudinal axis of the roller cage in the cage pockets and spaced from one another circumferentially, profiled rollers having end pins that engage in the bearing pockets of the rim rings of the roller cage, wherein the bearing pockets are radially open for the radial insertion of the profiled rollers and each have an operating seat for the profiled rollers and have an installation seat for the profiled rollers which is radially spaced from the operating seat, and wherein each profiled roller is held in the installation seat so as to be prevented from falling out of the roller cage radially, the profiled rollers being arranged, for the installation of the roller cage element, on a first pitch circle arranged around a cage axis and being arranged, for operation of the roller screw drive, on a second pitch circle arranged around the cage axis.

2. The roller cage element according to claim 1, wherein the roller cage has projections arranged distributed over a circumference and arranged along the longitudinal axis, wherein the rim rings are arranged at axial ends of the projections, and wherein the projections arranged adjacent to one another delimit cage pockets for receiving the profiled rollers.

3. The roller cage element according to claim 2, wherein the bearing pockets on each rim ring are each delimited circumferentially by opposing pocket walls, which radially form pairs of retaining portions for the profiled rollers, each retaining portion being associated with one of the first and second pitch circles.

4. The roller cage element according to claim 3, wherein the pocket walls, viewed axially, each have two curved wall portions disposed radially one behind the other, which engage around the pins of the profiled rollers, a clear spacing between two opposing curved wall portions associated with one of the first and second pitch circles being smaller than a pin diameter of the pins of the profiled rollers.

5. The roller cage element according to claim 4, wherein the bearing pocket has a clear opening width which is smaller than the diameter of the pins.

6. The roller cage element according to claim 4, wherein the first pitch circle diameter in the installation seat is larger than the second pitch circle diameter in the operating seat.

7. The roller cage element according to claim 4, wherein the first pitch circle diameter in the installation seat is smaller than the second pitch circle diameter in the operating seat.

8. The roller cage element according to claim 1, wherein the bearing pockets each have a U-shaped contour when viewed axially.

9. A method for installing a roller cage element on a threaded spindle of a roller screw drive, the roller cage element comprising:
a roller cage having cage pockets and rim rings having bearing pockets; and
profiled rollers arranged around a longitudinal axis of the roller cage in the cage pockets and spaced from one another circumferentially, the profiled rollers having end pins that engage in the bearing pockets of the rim rings of the roller cage, wherein the bearing pockets are radially open for the radial insertion of the profiled rollers and each have an operating seat for the profiled rollers and have an installation seat for the profiled rollers which is radially spaced from the operating seat, and wherein each profiled roller is held in the installation seat so as to be prevented from falling out of the roller cage radially, the profiled rollers being arranged, for the installation of the roller cage element, on a first pitch circle arranged around a cage axis and being arranged, for operation of the roller screw drive, on a second pitch circle arranged around the cage axis, the method comprising the following steps:
inserting the profiled rollers into the roller cage in the installation seat, wherein the roller cage element has an inner enveloping circle diameter that is larger than the outer diameter of the threaded spindle;
applying the roller cage element to the threaded spindle;
radially displacing the profiled rollers into the operating seat, wherein the profiled rollers are in engagement with the threaded spindle; and
screwing a nut onto the roller cage element.

10. A method for installing a roller cage element into a nut element roller screw drive, the roller cage element comprising:
a roller cage having cage pockets and rim rings having bearing pockets; and
profiled rollers arranged around a longitudinal axis of the roller cage in the cage pockets and spaced from one another circumferentially, the profiled rollers having end pins that engage in the bearing pockets of the rim rings of the roller cage, wherein the bearing pockets are radially open for the radial insertion of the profiled rollers and each have an operating seat for the profiled rollers and have an installation seat for the profiled rollers which is radially spaced from the operating seat, and wherein each profiled roller is held in the installation seat so as to be prevented from falling out of the roller cage radially, the profiled rollers being arranged, for the installation of the roller cage element, on a first pitch circle arranged around a cage axis and being arranged, for operation of the roller screw drive, on a second pitch circle arranged around the cage axis, the method comprising the following steps:
inserting the profiled rollers into the roller cage in the installation seat, wherein the roller cage element has an outer enveloping circle diameter that is smaller than an inner diameter of the nut element;
inserting the roller cage element into the nut element;
radially displacing the profiled rollers into the operating seat, in which the profiled rollers are in engagement with the nut element; and
screwing a threaded spindle into the roller cage element.

11. The method according to claim 9, wherein the roller cage has projections arranged distributed over a circumference and arranged along the longitudinal axis, wherein the rim rings are arranged at axial ends of the projections, and wherein the projections arranged adjacent to one another delimit cage pockets for receiving the profiled rollers.

12. The method according to claim 11, wherein the bearing pockets on each rim ring are each delimited circumferentially by opposing pocket walls, which radially form pairs of retaining portions for the profiled rollers, each retaining portion being associated with one of the first and second pitch circles.

13. The method according to claim 12, wherein the pocket walls, viewed axially, each have two curved wall portions disposed radially one behind the other, which engage around the pins of the profiled rollers, a clear spacing between two opposing curved wall portions associated with one of the first and second pitch circles being smaller than a pin diameter of the pins of the profiled rollers.

14. The method according to claim 10, wherein the roller cage has projections arranged distributed over a circumference and arranged along the longitudinal axis, wherein the rim rings are arranged at axial ends of the projections, and wherein the projections arranged adjacent to one another delimit cage pockets for receiving the profiled rollers.

15. The method according to claim 14, wherein the bearing pockets on each rim ring are each delimited circumferentially by opposing pocket walls, which radially form pairs of retaining portions for the profiled rollers, each retaining portion being associated with one of the first and second pitch circles.

16. The method according to claim 15, wherein the pocket walls, viewed axially, each have two curved wall portions disposed radially one behind the other, which engage around the pins of the profiled rollers, a clear spacing between two opposing curved wall portions associated with one of the first and second pitch circles being smaller than a pin diameter of the pins of the profiled rollers.
